(19) United States
(12) Patent Application Publication
(10) Pub. No.: US 2026/0251788 A1
(43) Pub. Date: Aug. 27, 2026

(54) Digital 2D Array Ultrasound Transducer

(71) Applicant: Bernard Joseph Savord, Andover, MA (US)

(72) Inventor: Bernard Joseph Savord, Andover, MA (US)

(21) Appl. No.: 19/060,661

(22) Filed: Feb. 22, 2025

(51) Int. Cl. G01S 15/89; G01S 7/534

(52) U.S. Cl. CPC G01S 15/8977; G01S 7/534

(57) ABSTRACT

An ultrasound imaging transducer receives echo data from a matrix of elements distributed in two or more dimensions. Received echo data is delayed using an analog delay circuit consisting of an array of signal storage capacitors addressed by input and output switches addressed by input and output counters. The output of the ARAM is digitized by an analog to digital converter (ADC). Digital data is processed and streamed to a base system for further processing to form and display an image. The input counter address update phase is programable in quanta less than or equal to one half the input counter address update period. The output counter address update phase is held at a fixed phase relationship to the ADC sampling clock. The signal delay through the ARAM is controlled by the summation of two or more controls.

### RELATED APPLICATIONS

This application claims the benefit of U.S. Provisional Patent Application Ser. No. 63/557,549, “DIGITAL 2D ARRAY ULTRASOUND TRANSDUCER”, filed Feb. 25, 2024, the content of which is incorporated herein by reference in its entirety for all purposes.

### BACKGROUND

Digitizing ultrasound echoes within an ultrasound imaging transducer lowers the cost of the imaging system since a front end is not needed within the system, increases the cable flexibility and reliability with fewer connections by streaming multiple channels in each connection and increases performance by allowing more digitized channels than the system otherwise would have. However, digitization within an ultrasound transducer has unique challenges for matrix transducers with elements distributed in two dimensions meant for 4D imaging. Given the large element count of several thousand, processing is performed in two stages. In the first stage elements are grouped into sub-arrays. Analog delay and sum beamforming is applied within the sub-array using an analog random-access memory (ARAM) (sometimes referred to in the literature as an analog first in-first out (FIFO) memory or switched capacitor delay (SCD)) for the delay element. The summed output of the sub-array is then digitized using an analog to digital converter (ADC) for further processing in the digital domain. In current state of art, the ARAM is large with many stages to provide fine quantization of possible delays values resulting in large real estate and power. Sampling within the analog RAM interacts with subsequent sampling in the ADC requiring space consuming reconstruction filters. A large amount of data is needed to configure the large ARAMs within the transducer. This large amount of data makes it particularly challenging to dynamically update the ARAM delays during the receive interval to continuously update the focus with depth. The ADC doesn't have sufficient dynamic range to support continuous wave (CW) mode.

### SUMMARY

According to an aspect of the present disclosure the ARAM size is reduced by a factor of two or more by providing control of the input phase of the ARAM sampling.

According to another aspect of the present disclosure, interaction between the ARAM sampling and ADC sampling are eliminated by maintaining a fixed phase relationship between the ARAM output phase and ADC sampling phase thereby eliminating the need for a reconstruction filter.

According to another aspect of the present disclosure, the amount of data required to configure the ARAM is reduced by the smaller ARAM size and by a novel scheme using timers and rate multipliers to configure the ARAM.

According to another aspect of the present disclosure, the ARAM delays can be dynamically updated during the receive interval using a simple state machine.

According to another aspect of the present disclosure, a switch bypasses the ADC in CW mode to form an analog summing node to feed directly to a CW processor.

### BRIEF DESCRIPTION OF THE DRAWINGS

The representative embodiments are best understood from the following detailed description when read with the accompanying drawing figures. Wherever applicable and practical, like reference numerals refer to like elements.

FIG. 1 is a simplified diagram of an ultrasound system for 4D imaging a portion of a body using a matrix of transducer elements partitioned into receive sub arrays with digitization at the transducer and streaming resulting digital data to the base system as presented in this disclosure.

FIG. 2 is a simplified diagram of the circuitry serving each element of a receive sub-array.

FIG. 3 is a simplified diagram of circuitry for the clock divider state machine shown in FIG. 2.

FIG. 4 is a simplified timing diagram for the circuitry shown in FIG. 3.

FIG. 5 is a simplified timing diagram of the sub-array element circuitry of FIG. 2.

FIG. 6 is a simplified block diagram showing how control signals for each element within a sub-array are connected at the sub-array level to produce a two dimensional (2D) linear delay slope across a sub-array.

FIG. 7 is a simplified circuit diagram for the ½ rate multiplier shown in FIG. 6

FIG. 8 is a simplified timing diagram for the ½ rate multiplier shown in FIG. 6

FIG. 9 is a simplified circuit diagram for the timer shown in FIG. 6

FIG. 10 is a simplified block diagram for a cart-based application of this invention.

FIG. 11 is a simplified block diagram for a cell phone or tablet application of this invention.

FIG. 12 is a simplified block diagram for a wireless application of this invention.

### DETAILED DESCRIPTION

In the following detailed description, for the purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third, etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

The terminology used herein is for purposes of describing particular embodiments only and is not intended to be limiting. As used in the specification and appended claims, the singular forms of terms “a,” “an” and “the” are intended to include both singular and plural forms, unless the context clearly dictates otherwise. Additionally, the terms “comprises,” “comprising,” and/or similar terms specify the presence of stated features, elements, and/or components, but do not preclude the presence or addition of one or more other features, elements, components, and/or groups thereof. As used herein, the term “and/or” includes any and all combinations of one or more of the associated listed items.

As used in the specification and appended claims, and in addition to their ordinary meanings, the term ‘approximately’ mean to with acceptable limits or degree. For example, “approximately 20 GHz” means one of ordinary skill in the art would consider the signal to be 20 GHz within reasonable measure.

This invention relates to medical ultrasound imaging of 3D structures within a patient using a matrix of transducer elements distributed in two or more dimensions. Prior art uses a two stage beamforming architecture with analog processing of sub-array groupings of elements at the transducer in the first stage followed by digitization and second stage beamforming within a base system. Representative examples of this method can be found in C. Chen et al., “A Front-End ASIC With Receive Sub-array Beamforming Integrated With a 32×32 PZT Matrix Transducer for 3-D Transesophageal Echocardiography,” in IEEE Journal of Solid-State Circuits, vol. 52, no. 4, pp. 994-1006, April 2017 as well as Y. Katsube et al., “27.6 Single-chip 3072ch 2D array IC with RX analog and all-digital TX beamformer for 3D ultrasound imaging,” 2017 IEEE International Solid-State Circuits Conference (ISSCC), San Francisco, CA, USA, 2017, pp. 458-459

In this prior art, the analog delay elements within the first stage use sampled analog signals. An analog random-access memory (ARAM) (sometimes referred to in the literature as an analog first in-first out (FIFO) memory or switched capacitor delay (SCD)) is used for the analog delay in the first beamformer stage. These sampled signals are reconstructed to continuous waveforms using an analog reconstruction filter prior to sampling by an analog to digital converter (ADC) in the second stage. The reconstruction eliminates any interaction between the two sampling operations allowing the sampling within the system to be at an arbitrary phase respect to that within the transducer. The reconstruction filter is typically formed by the transducer cable capacitance and inductors within the cable assembly along with an anti-aliasing filter within the system. These reconstruction filters are large and would be difficult to integrate within a transducer assembly head.

Prior art that sends analog sub-array outputs to a base system for digitization is limited in performance by the number of channels available within the base system, have relatively large cables with associated sonographer strain and relatively large system costs to support the digitization within the base system. Cable diameter is especially an issue with catheter transducers where the available catheter diameter is limited. To solve these issues, digitization of sub-array outputs within the transducer has been proposed in Chao Chen et al. “A Pitch-Matched Front-End ASIC With Integrated Subarray Beamforming ADC for Miniature 3-D Ultrasound Probes” IEEE Journal of Solid-State Circuits, September 2018 DOI: 10.1109/JSSC.2018.2864295

This proposed architecture require sampling the ADCs and ARAM at a high rate to achieve the desired delay quantization. This high sample rate is in excess of that required to meet the Nyquist sampling requirement to adequately sample the spectra of the ultrasound signal. Typically, to achieve good beam formation, one needs a delay quantization of 1/16^{th} of the period of the signal center frequency. For wideband signals, one needs only sample at approximately 3 to 4 times the signal center frequency (twice the upper band edge frequency) to meet the Nyquist sampling criteria. Sampling at the rate needed for good quantization is then 4 to 5 times the rate needed to adequately sample the spectra. This requires 4 to 5 times the power, data transmission rate and ARAM real-estate then needed if one were to sample at the lower Nyquist criteria rate.

According to an aspect of this disclosure, the ARAM size is reduced by running at approximately the sample rate needed to meet the Nyquist sampling criteria, but with fine delay quantization achieved by control of the sampling phase at the ARAM input to a quantization a fraction of the sample period. The sampling phase of the ARAM output is held at a fixed phase relationship with the ADC sampling eliminating the need for a reconstruction filter between the ARAM and ADC.

Another issue with the prior art is the large amount of data needed to program the analog delays for each of the approximately 4000 elements within the transducer. If each analog delay takes 20 bits to program, 80000 bits of data would be needed to program the delays for a complete transducer. To load this data within the desired 10 us each acoustic line, one would need 80 data lines running at 100 Mbs each resulting in a large transducer cable assembly and system complexity.

To reduce the amount of data required S. Blaak et al., “Design of a micro-beamformer for a 2D piezoelectric ultrasound transducer,” 2009 IEEE International Ultrasonics Symposium, Rome, Italy, 2009, pp. 1338-1341 proposes to program all the delays within each sub-array identically for each sub-array. The idea is that the steering component of delay is identical within each sub-array. Unfortunately, the focus portion of the delay is not identical within each sub-array requiring separate delays for each sub-array to achieve good focus.

This invention disclosure adopts the approach of FIG. 14 in U.S. Pat. No. 6,126,602A whereby the delays within a given sub-array are assumed to be linear in both dimensions across the sub array. Only slopes kx and ky need to be programmed for each sub array. These linear delay slopes are achieved using digital timers and rate multipliers as will be described when discussing the figures.

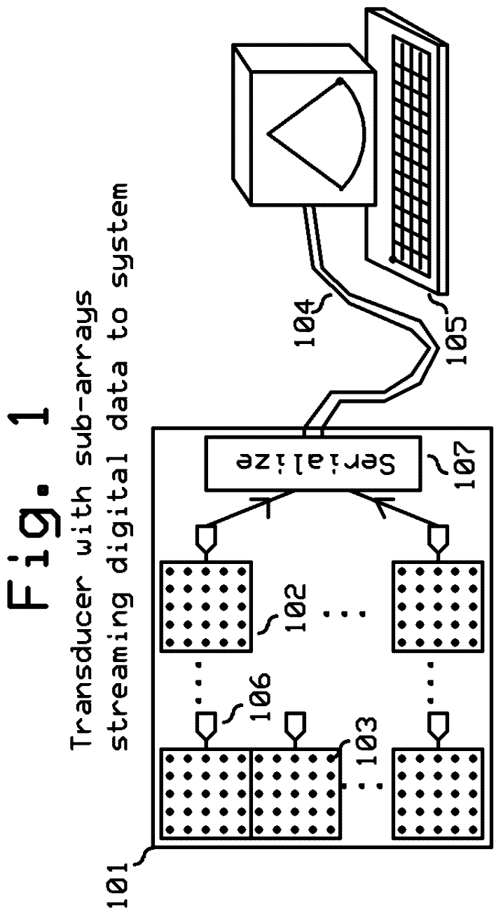

FIG. 1 is a simplified diagram of a digital ultrasound (US) imaging system for imaging a portion of a body using a transducer 101 with a matrix of transducer elements 103 distributed in two dimensions partitioned into sub-array groups 102 of 5×5 elements each. Analog to digital converters 106 (ADCs) on the output of each sub-array beamformer (not shown) digitize the received ultrasound echo data. The data is then serialized 107, then streamed over a communication channel into a base system 105 for further processing and image display. The communication channel can be a wire bundle 104, optical fiber bundle or wireless communication and still be within scope of this invention.

Sub-arrays can be any other shape including one dimensional sub-arrays and any size from 2×1 up to single sub-array that includes the whole matrix of elements and still be considered within the scope of this invention. Furthermore, the shape and size of the groupings could change throughout the array and be configured differently for each acoustic transmission as in U.S. Pat. Nos. 9,739,885B2 and 11,911,218B2 and still be within the scope of this patent. Typical sizes for a transducer for Adult transthoracic cardiac imaging are: A matrix of 80×5 elements distributed in 160 sub-arrays of 5×5 elements each.

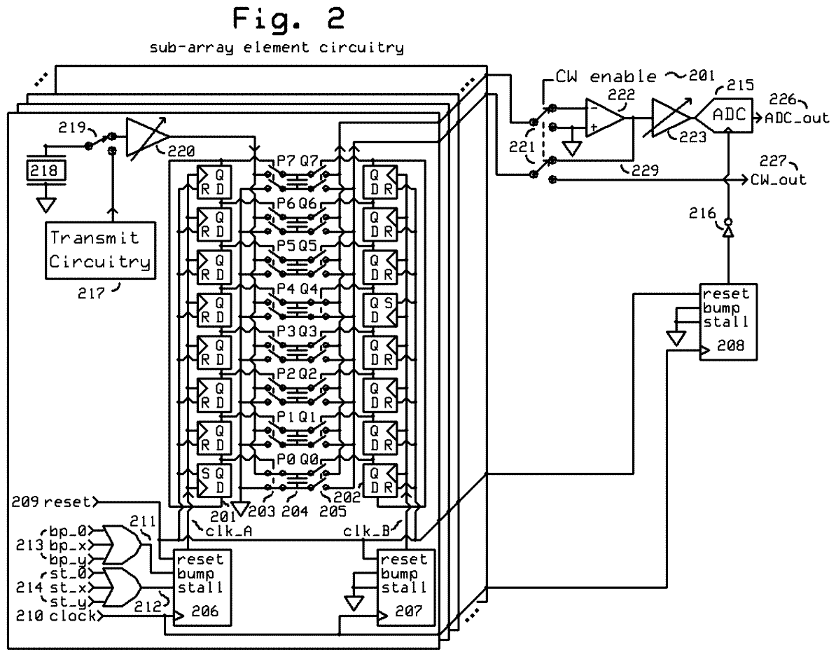

FIG. 2 shows the circuitry associated with a sub-array of transducer elements for the proposed invention. An analog random access memory (RAM) is used for beamforming delays as known in the art such as described in the previously mentioned references. A string of flip-flops 201 forms a ring counter selecting which capacitor to write a signal sample into. A 2^{nd} string of flip flops 202 forms a ring counter for selecting which sample to read out of the ARAM. Switches 203 and 205 write samples into and read samples out of ARAM sample capacitors 204. A reset signal 209 initializes the flip-flops so that a single differential switch is enabled on the input side and output side of the ARAM. Once reset is placed low, a logic high is circulated through the flip flops thereby sequentially enabling the switches one at a time, writing and then reading sampled analog signals into the capacitors. The signal delay is set by the difference in location of the logic high between the read and write sides of the ARAM. In the example of FIG. 2, a delay of 4 samples is programmed upon reset. Flip flops with a reset input “R” are set to logic low upon reset while those with a set input “S” are set to a logic high upon reset. The delay in this example was chosen to be the middle value of the possible delay range. The number of capacitors sets the maximum delay range. In this example 8 capacitors are used. Two to over a hundred ARAM capacitors could be used within the scope of this invention. Initial delay values programmed on reset could be from 0 to the maximum number of capacitors.

The ARAM flip flops are clocked by a divider state machine 206 and 207 operating from a high frequency master clock 210. The master clock could be in the range of 10 Mhz to 1 Ghz depending on the transducer application. Clock divider state machines 206,207 provide the desired sample rate to the ARAMs equal to the master clock frequency divided by a number N greater than or equal to 2. It is recommended to set this sample rate greater than twice the highest signal frequency to meet the Nyquist sampling criteria.

The count of divider 206 can be increased or decreased by bump 211 and stall 212 signals to advance or retard the ARAM delay by one master clock period. Any initial delay value can be adjusted from the initial reset value by holding either the bump 211 or stall signals 212 high for the desired amount of delay adjustment. Another aspect of this disclosure is that the delay values can be adjusted in quanta of master clock periods. Since the master clock rate is higher than the sample rate, fine delay adjustments can be achieved without the need for a large number of sampling capacitors.

Another aspect of this disclosure is that the phase of counter 207 is fixed independent of delay allowing ARAM output to have fixed sample phase with respect to the ADC 215 eliminating the need for a reconstruction filter.

Divider 208 (with circuitry similar to 206 and 207) and inverter 216 set the ADC sampling phase 180 degrees from that of the ARAM output allowing for settling time prior to conversion.

Schemes for addressing the ARAM other than shown in FIG. 2 are considered within the scope of this invention. These schemes include the use of binary counters, gray code counters, address decoders or any other memory addressing schemes known in the art.

Methods of controlling the ARAM address update rates other than shown in FIG. 2 are also considered within the scope of this invention. For example, one could use synchronous methods to clock the address counters at the master clock rate and use periodic clock enables to produce an address update rate less than the master clock rate.

The ARAM outputs are placed across an operational amplifier (OPAMP) 222. The output of this OPAMP is the ARAM output signals averaged over the all the outputs in the sub-array. This OPAMP configuration, along with the use of differential switching within the ARAM minimizes the loading effects of parasitic routing capacitances.

Variable gain stage 223 provides compensation for signal attenuation with depth in addition to any compensation provided in preamplifier stage 220.

ADC 215 digitizes the averaged output signal from the sub-array ARAM outputs. This ADC can use flash, pipe-lined, signa delta, successive approximation (SAR), or any other method known in the art. This ADC preferably uses low power SAR methods as described in A. Bhat “Low power 12b SAR ADC for 3D ultrasound”, Master thesis from Eindhoven University of Technology, 31 Oct. 2014.

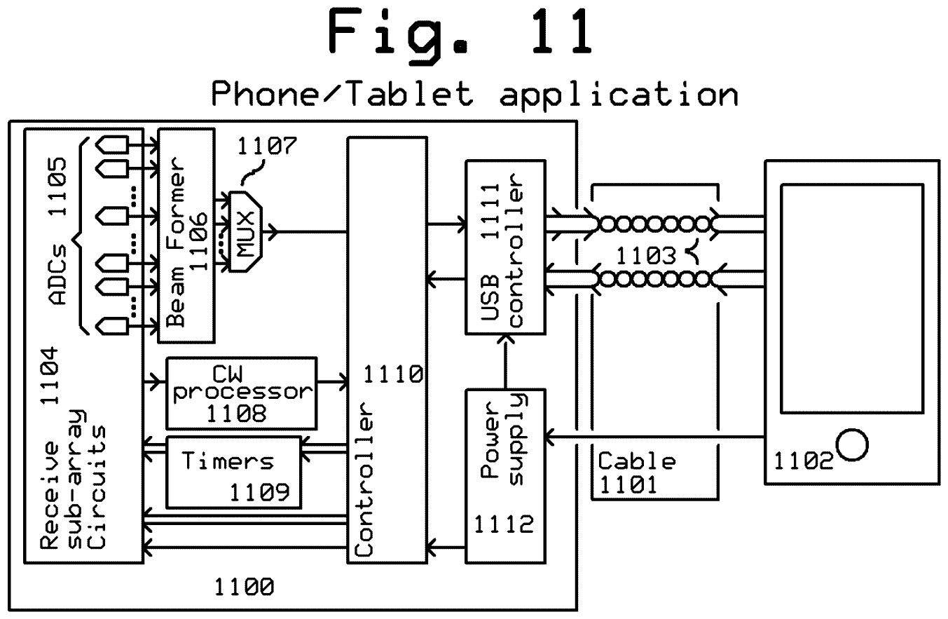

ADC output 226 is sent for further processing as discussed in FIGS. 10 through 12.

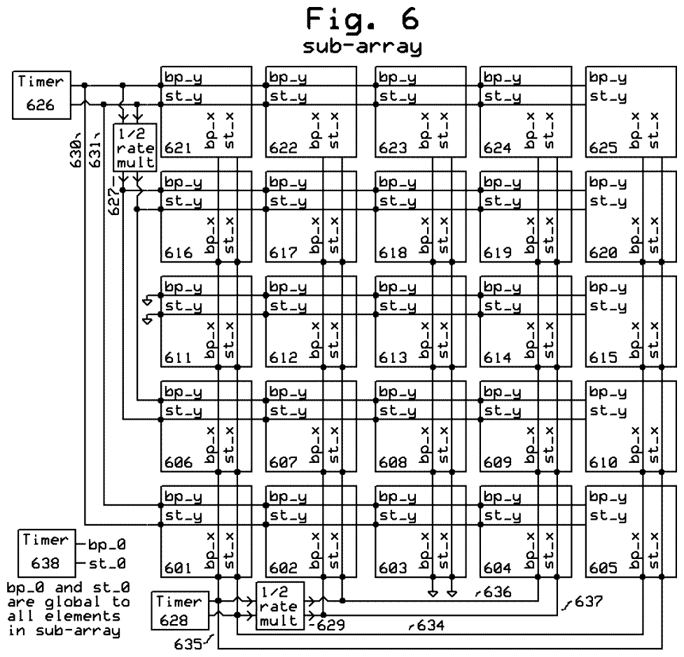

Another aspect of this invention is a reduction in the amount of control data used to program the ARAM. To achieve this, the bump and stall signals are split into _x, _y and _0 components 213-214. This when combined with circuitry to be described in FIG. 6 allows linear delay profiles with independent slopes in x and y dimensions to be programmed across a sub-array similar to the kx and ky slopes described in FIG. 14 of U.S. Pat. No. 6,126,602A.

The bp_0 and st_0 component provide an optional overall delay offset common to all elements in the sub-array. This offset allows one to program an intra-sub-array delay profile in CW mode. In other non-CW modes, the intra-sub-array profile is preferably provided by digital processing post ADC.

The bump 213 and stall 214 signals can be used to update the delay during the receive interval to provide dynamic receive focusing. These signals could be provided by a focus engine state machine as described in U.S. Pat. No. 5,522,391A.

Transmit circuitry 217 using techniques known in the art excite transducer element 218 with a high voltage pulse through transmit receive switch 219 generating acoustic energy into the body being imaged.

Transducer element 218 can be piezoelectric, capacitive micro machined, piezoelectric micro-machined or other suitable technology

Transducer element 218 receives reflected echoes from the body creating received electrical signals to be processed. These echoes pass through transmit receive switch 219 and are amplified by preamplifier 220 and sent to the ARAM input where signals are delay as previously discussed.

Preamplifier 220 may include a variable gain stage to apply time gain compensation for signal attenuation with depth as is known in the art.

It is known in the art that today's ADCs do not have enough dynamic range to handle CW mode. Another aspect of current disclosure is to provide an analog summing node 227 to a CW processor (not shown) within the base system. Switch 221 when configured in CW mode sums all the analog ARAM outputs of the elements together. In the embodiment shown, the summing node is in the RF domain. Alternatively, mixers can be implemented within each element cell, or within each receive group, or global to all elements to provide baseband (US20230273306A1) or intermediate frequency outputs.

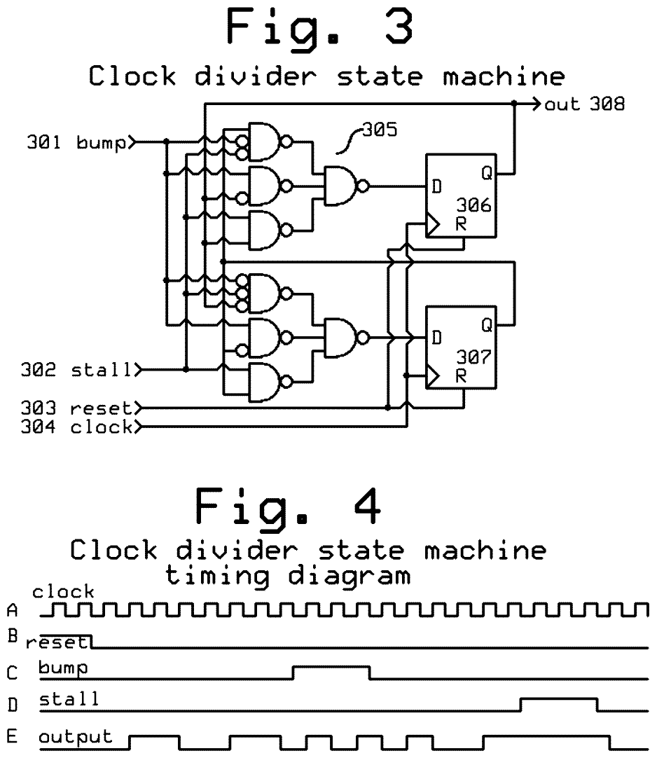

FIG. 3 shows circuitry used for clock divider state machines 206, 207 and 208 of FIG. 2. The example in FIG. 3 is for a clock division ratio of N=4. Similar circuitry could be designed for any N from 2 to 16, or even a programmable N and be within the scope of this invention.

A state machine formed by logic 305 and flip flops 306 and 307 produces an output 308 that is at a rate of ¼ the clock 304 rate when bump 301 and stall 302 signals are held logic low. Holding bump signal 301 high produces an output at ½ the clock rate during the duration that bump is held high. Holding stall signal 302 high stops the output signal from changing during the duration that the stall signal is held high. A reset signal forces the output low.

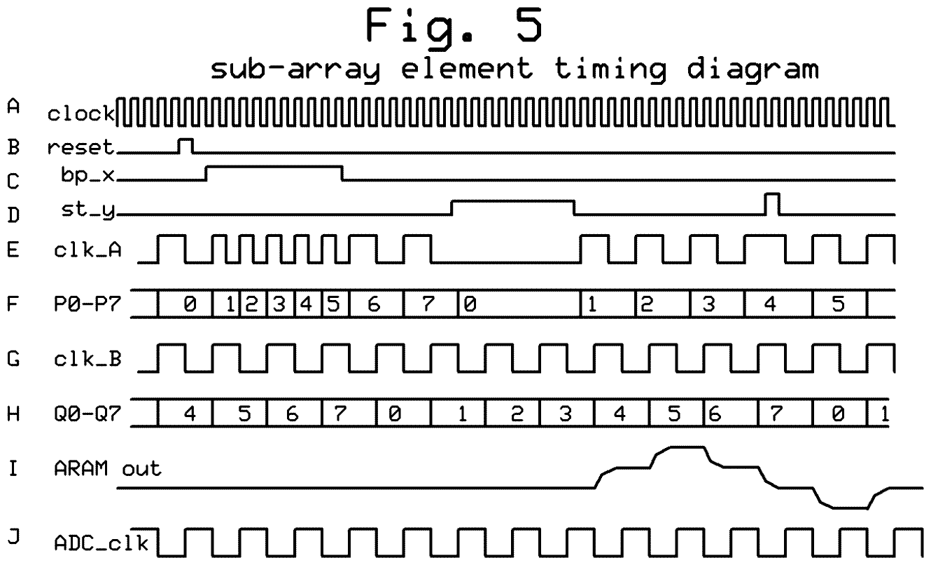

FIG. 4 shows the timing diagram produced by the circuitry of FIG. 3. Waveform A is the clock feeding the state machine. Reset signal (waveform B) initially is set high to force output (waveform E) low. During the period that bump (waveform C) and stall (waveform D) signals are low, output E produces a waveform at ¼ the clock frequency. When the bump signal (waveform C) is high, the output (waveform E) occurs at a rate or ½ the clock thereby advancing the phase of the ring counter 201 of FIG. 2. When the stall signal (waveform D) is held high, the output (waveform E) does not move thereby retarding the phase of ring counter 201 of FIG. 2.

FIG. 5 shows the timing diagram of circuitry of FIG. 2. Waveform A is the clock provided to clock divider state machines 206,207,208. In this example the clock divider ratio N is set to 4, and can be designed for any other value from 2 to 16 and be within the scope of this invention.

Waveform F corresponds to signals P0 through P7 in FIG. 2. The number within a waveform segment indicates which of P0 through P7 is at logic high during that segment indicating which capacitor the signal into the ARAM is captured by.

Waveform H corresponds to signals Q0 through Q7 in FIG. 2. The number within a waveform segment indicates which of Q0 through Q7 is at logic high during that segment indicating which ARAM capacitor is applied to the ARAM output. The signal delay through the ARAM is the time between when a particular number on the P waveform subsequently appears on the Q waveform.

Waveforms E (clk_A) and G (clk_B) are the clocks for the ARAM input 201 and output 202 ring counters.

A reset signal (waveform B) sets the ring counter clocks (clk_A and clk_B) low and P0 and Q4 high for an initial delay of 16 clocks of waveform A (4 cycles of clock_B). Delay is changed by bump and stall components bp_x (waveform C) and st_y (waveform D). The total modification to the initial delay is the sum of these bp_x and st_y components allowing for the delay to be the sum of components from 2 dimensions so as to make a 2 dimensional linear profile in delay across a patch with an optional overall offset set by bp_0 and st_0. Note that in this example st_x, bp_y, bp_0 and st_0 are set low and are not shown. Setting bp_x high increases the delay by an amount equal to the time bp_x is set high. Setting st_y decreases the delay by an amount equal to the time st_y is set high. The net delay change is then the time bp_x is high minus the time st_y is high. Adding this to the initial 16 clock delay gives a net delay once bp_x and st_y are low of 21 clocks (5.25 cycles of clk_B). One can see this from the time difference when P1 goes high to Q1 subsequently going high.

Delay values can be changed dynamically during receive interval by blipping bump and stall components during the receive interval. One such “blip” is shown near the end of the st_y signal. U.S. Pat. No. 5,522,391A shows a state machine for generating appropriate update “blips”.

Another aspect of this disclosure is that the ARAM output clock has fixed phase relationship to the ADC sampling clock (waveform J). This fixed phase relationship eliminates the need for a reconstruction filter between the ARAM and ADC. In this example, the phase difference between clk_B and ADC_clk is 180 degrees. Any other fixed phase difference from 0 to 359 degrees is within scope of this invention.

Waveform I shows the analog signal at the ARAM output. The signal starts to change when clk_B changes. The waveform takes some time to settle due to the resistance of the ARAM switches and limited bandwidth of opamp 222. The ADC capture is delayed 180 degrees with respect to clk_B to allow for this settling time.

FIG. 6 shows how the bump and stall components are configured for a sub array group of 5×5 elements 601-625 to produce a 2 dimensional linear delay profile across the elements within a sub-array. The assumption is that any desired delay profile looks linear across a small sub-array with an optional overall offset provided by bp_0 and st_0 produced by timer 638. The techniques shown could be applied to any other shape including one dimensional sub-arrays and any size from 2×1 up to the whole matrix of elements and still be considered within the scope of this invention. Furthermore, the shape and size of the groupings could change throughout the array and be configured differently for each acoustic transmission as in U.S. Pat. No. 9,739,885B2 and U.S. Pat. No. 11,911,218B2 and still be within the scope of this patent.

The delay for the upper left element is set by timers 626, 628 and 638. These timers produce the bp and st waveforms of FIG. 5.

Rows of elements in the sub-array share by_y and st_y signals. Columns of elements share bp_x and st_x signals. bp and st signals for the middle row and column of elements are set to ground thereby setting the delay of the middle element of the sub-array to the middle delay range of the ARAM when the reset signal of FIG. 2 is set high plus any overall offset set by bp_0 and st_0. bp and st x and y signals are swapped for rows and columns on opposite sides of the center line since a linear delay profile has opposite sign of the delay offset with respect to the center element at opposite side of center. For example, if one increases the delay left of center, the delay will decrease right of center.

Delay offsets with respect to the center are proportional to the distance from the center. To achieve this, the timer signals produced by timers 627 and 628 need to be scaled in width according to x and y location of the particular row and column in the sub-array. A rate-multiplier is used to scale this width. Note that the width per se is not scaled, but the number of clocks that the signals are held high is scaled. Is this example a ½ rate multiplier 622,629 is used to make the appropriate scaling. Other sub-array sizes require different rate multi-pliers. For example, a sub-array of 7×7 elements would require ⅓ and ⅔ rate multipliers.

One can appreciate that three timer signals can produce a linear delay profile across the sub-array of any slope or orientation and offset thereby dramatically reducing the amount of data needed to program the sub-array delays. Other methods of configuring bp and st signals are possible and could potentially reduce the amount of data further by sharing signals across multiple sub-arrays. One can also replace the rate-multipliers with additional timers. These alternative configurations as well as others developed by one skilled in the art are within the scope of this invention.

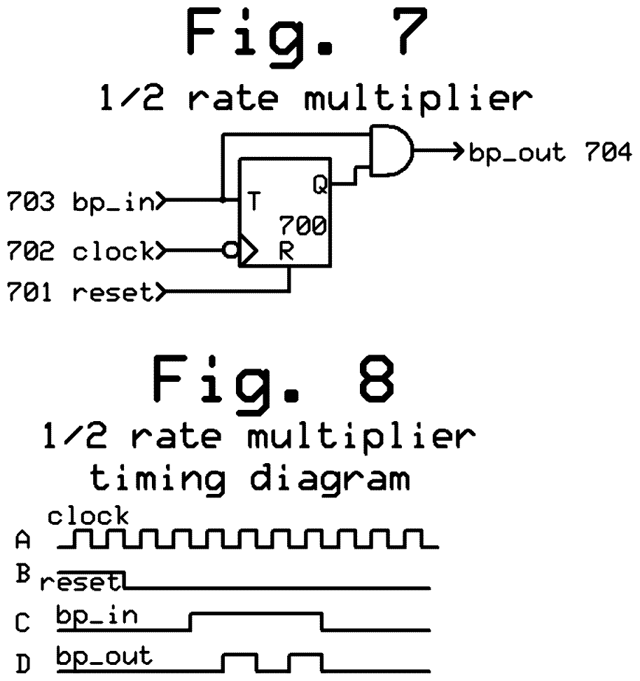

FIG. 7 shows circuitry for a 1/2 rate multiplier used in FIG. 6. Only the circuit used for a bp signal is shown. An identical circuit, not shown, is use for the st signal.

A toggle flip flop 704 changes state during a negative clock 702 transition when bp_in 703 is high. When gated by bp_in, bp_out 704 produces a signal that is high for ½ as many clocks as bp_in is high. A reset signal 701 resets the circuit to an initial condition with logic low output.

FIG. 8 shows the timing diagram for the 1/2 rate multiplier of FIG. 7. A reset signal (waveform B) resets the circuit to logic low output. A bp_in signal (waveform C) produces a toggling bp_out signal (waveform D) while high thereby producing a high output for half as many clocks (waveform A) as bp_in.

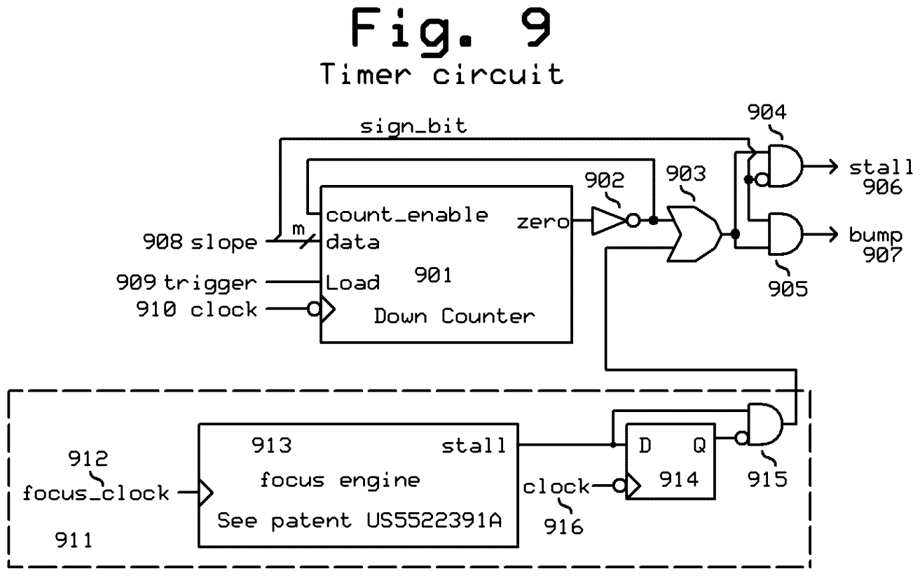

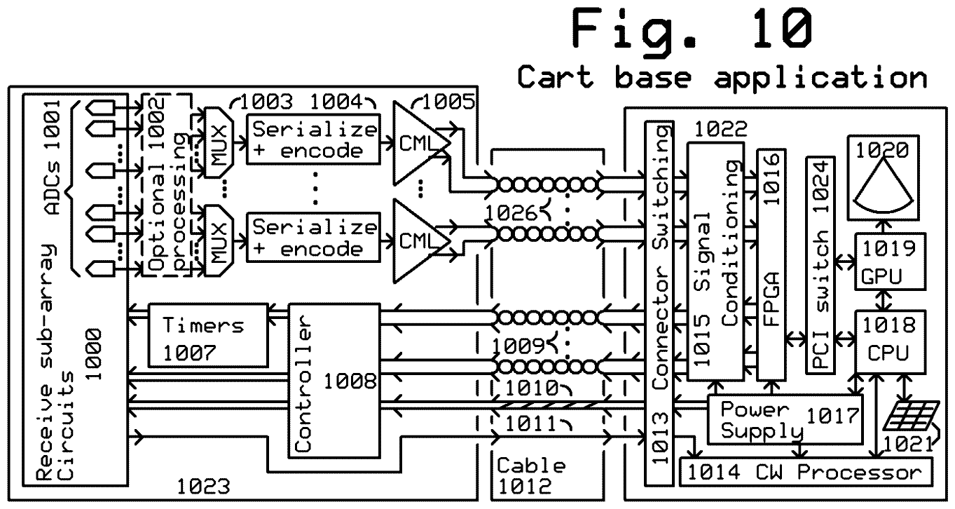

FIG. 9 shows circuitry associated with the timers 626 and 628 of FIG. 6.

The slope input 908 sets the width of the bump or stall signal to be produced in clock 910 periods. The sign bit of slope 908 determines whether a bump 907 or a stall 906 signal is produced using gates 904 and 905. Down counter 901 counts the clock periods and stops when the desired count is reached. Trigger 909 starts the counter. Note that separate triggers for timers 626 and 628 occurring at different times are needed to ensure that bump and stall signals for these two different timers do not overlap in time.

Optional circuitry 911 is used if one wants to update the slope dynamically with depth. Focus engine 913 (described in U.S. Pat. No. 5,522,391) produces update signals of one focus_clock 912 width at appropriate times to update the slope. Note that this focus engine as described in U.S. Pat. No. 5,522,391 produces updates to a delay value with respect to the scan line intercept and not a delay slope across a sub-array. Instead, the coefficients of the focus engine are modified to produce the desired delay profile needed for the corner element of the sub-array with respect to the center element. For small patch sizes, any error is sufficiently small and can be neglected. Logic 914 and 915 re-times the update signal with respect to clock 916.

It is important that bump and stall updates for timers 626 and 628 do not occur simultaneously. To ensure this, the focus_clock 912 runs at ½ the rate of clock 910. Timer 626 and 628 use opposite phase of this ½ rate clock for their respective focus engines guaranteeing non-overlap of updates.

FIGS. 10,11 and 12 show how this invention can be integrated into 3 potential applications.

FIG. 10 shows a traditional application with a base system, typically on a cart.

A transducer 1023 is connected to a base system 1022 through a cable assembly 1012. A collection of sub-array circuits 1000 as shown in FIGS. 2 and 6 with associated analog to digital converters 1001 produce digital outputs that are optionally processed with circuitry 1002 then multiplexed 1003, serialized and encoded 1004 and sent over wires 1006 using current mode logic (CML) drivers 1005 to the base system 1002 as described in US20210007717A1. The cable assembly shown in the figure uses twisted pair wiring for the data. Alternatives such as single ended coax or optical fiber are also considered within scope of this invention. Other drivers than CML such as LVCMOS, LVS or other digital drivers are also within scope of this invention.

Optional processing circuitry 1002 could include a multi-line beamformer such as described in U.S. Pat. No. 11,841,425, signal compression, encoding or other processing.

The base system may include connector switches 1013 to allow switching between multiple transducers as described in WO2023213748A1. The signal conditioning block 1015 provides optional pre-amplification and equalization to compensate for cable loss. A field programable gate array (FPGA) 1016 acts as an interface to the PCIe switch 1024. This switch allows transducer data to be processed by a graphics processor unit (GPU) 1019 to provide beamforming, filtering and scan conversion. Alternatively, these functions could be provided by the FPGA 1016, or central processing unit (CPU) 1018. Processed data is provided to a display 1020.

A control panel 1021 interfaced to the CPU 1018 provides control to the transducer through FPGA 1016, signal conditioner 1015 and cable assembly 1012. A controller 1008 within the transducer controls timers 1007 that set the delays for the sub-arrays as well as provide other control signals needed in FIG. 2.

For CW Doppler mode, an analog summing node signal 1011 from the transducer is sent over cable assembly 1012 through connector switch 1013 to a CW processor 1014 within the base system. Spectral output from the CW processor is sent to the CPU for display.

Power Supply 1017 powers all circuitry including the transducer over cables 1010.

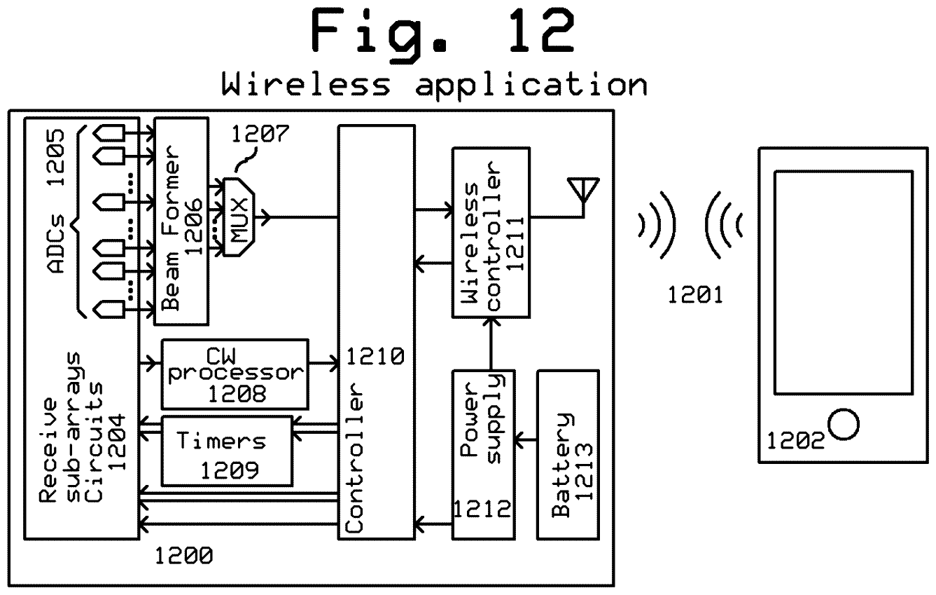

FIG. 11 shows a hand-held or tablet application using a universal serial bus (USB) cable interfaced to a cell phone or tablet.

A transducer 1100 is connected to a phone or tablet through a USB cable assembly 1101. A collection of sub-array circuits 1104 as shown in FIGS. 2 and 6 with associated analog to digital converters 1105 produce digital outputs that are then beamformed 1106 to produce multi-line outputs as described in U.S. Pat. No. 11,841,425. These multi-line outputs are multiplexed 1107 and interfaced through a controller 1110 to a USB controller 1111. USB outputs are then sent to the phone or tablet 1102.

Power is provided to the transducer over USB 1101 and power supply 1112. Configuration data is sent from the phone or tablet over USB to controller 1110 that then programs the timers 1109 needed to set the sub-array delays as well as other configuration data to the sub-arrays.

For CW Doppler mode, the analog signal summing node output from the sub-arrays is processed 1108 at the transducer assembly. Spectral data is sent to the phone or tablet over the USB pathway.

FIG. 12 shows an application using a wireless interfaced to a cell phone, tablet or other system.

A transducer 1200 is connected to phone, tablet or other system through a wireless interface 1201 such as wireless USB or any other wireless protocol. A collection of sub-array circuits 1204 as shown in FIGS. 2 and 6 with associated analog to digital converters 1205 produce digital outputs that are then beamformed 1206 to produce multi-line outputs as described in U.S. Pat. No. 11,841,425. These multi-line outputs are multiplexed 1207 and interfaced through a controller 1210 to a wireless controller 1211 and to the phone, tablet or other system by a wireless link.

A battery 1213 and supply 1212 provides power to the transducer. Configuration data is sent from the phone or tablet over the wireless interface to controller 1210 that then programs the timers 1209 needed to set the sub-array delays as well as other configuration data to the sub-arrays.

For CW Doppler mode, the analog summing node signal output from the sub-arrays is processed 1208 at the transducer assembly. Spectral data is sent to the phone or tablet over the wireless pathway.

As will be appreciated by one of ordinary skill in the art having the benefit of the present disclosure, devices, systems and methods of the present teachings, one can create a digital transducer containing a matrix of elements distributed in 2 or more dimensions for 4D imaging with a reduced ARAM size, without the need for a re-construction filter, with reduced data requirements to configure, with dynamic focus updates during the receive interval and with a high dynamic range path for CW mode.

Although methods, systems and components for implementing imaging protocols have been described with reference to several exemplary embodiments, it is understood that the words that have been used are words of description and illustration, rather than words of limitation. Changes may be made within the purview of the appended claims, as presently stated and as amended, without departing from the scope and spirit of the implementation of the present teachings. The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. An ultrasound imaging device, comprising:
an ultrasound imaging transducer with a matrix of acoustic elements distributed in two or more dimensions;
a base system for processing acoustic data from the imaging transducer to form and to display an image of the structure being imaged;
an array of capacitors to store analog signal samples forming storage elements of an analog delay circuit configured to delay echo signals received from an acoustic element within the imaging transducer;
a set of input switches within the analog delay circuit to store analog signal samples into the array of delay capacitors;
a set of output switches within the analog delay circuit to read analog signal samples out of the array of delay capacitors;
input and output counters to address the input and output switches of the analog delay circuit;
an analog to digital converter (ADC) connected to the output of the analog delay circuit producing a steam of data to be processed and sent to the base system for further processing;
means to control the phase of the input counter address updates;
whereby input counter address update phase is programmable in quanta less than or equal to one half the input counter address update period;
and whereby the output ring counter address update phase is held at a fixed phase relationship to the ADC sampling clock;
and whereby the signal delay through the analog delay circuit is controlled by the summation of two or more controls.

2. The ultrasound imaging system of claim 1, whereby the input and output counters are ring counters forming an analog first in-first out memory (FIFO).

3. The ultrasound imaging system of claim 1, whereby the summation of controls to program the signal delay value of the analog delay circuit is formed by the accumulated time duration of two or more digital timers operating in succession.

4. The ultrasound imaging system of claim 1, whereby the delay value of the analog delay can be updated dynamically to continuously update the focus with depth.

5. The ultrasound imaging system of claim 1, whereby the ADC can be bypassed to form an analog summing node for continuous wave (CW) processing.

6. A method of producing an ultrasound image comprising:
receiving acoustic echo data from a matrix of acoustic elements within a transducer distributed in two or more dimensions;
delaying received echo data using an analog delay circuit consisting of an array of signal storage capacitors addressed by input and output switches addressed by input and output counters;
controlling the address update phase of the input counter;
digitizing output of analog delay circuit using an analog to digital converter (ADC);
processing and streaming digitized data to a base system;
processing data at the base system to form an image;
displaying the image at the base system;
whereby input counter address update phase is programable in quanta less than or equal to one half the input counter address update period;
and whereby the output counter address update phase is held at a fixed phase relationship to the ADC sampling clock;
and whereby the input counter initial configuration is controlled by the summation of two or more controls.

7. The ultrasound imaging system of claim 6, whereby the input and output counters are ring counters forming an analog first in-first out memory (FIFO).

8. The ultrasound imaging system of claim 6, whereby the summation of controls to program the signal delay value of the analog delay circuit is formed by the accumulated time duration of two or more digital timers operating in succession.

9. The ultrasound imaging system of claim 6, whereby delay value of the analog delay circuit can be updated dynamically to continuously update the focus with depth.

10. The ultrasound imaging system of claim 6, whereby the ADC can be bypassed to form an analog summing node for continuous wave (CW) processing.
